(19) United States
(12) Patent Application Publication
(10) Pub. No.: US 2007/0101143 A1
(43) Pub. Date: May 3, 2007

(54) Semiconductor memory card

(76) Inventors: Yoshiaki Iwata, Osaka (JP); Naoya Takao, Hyogo (JP); Masahiro Oashi, Kyoto (JP); Ryota Tsukidate, Kanagawa (JP); Toshiro Nishio, Osaka (JP); Yasuo Endo, Chiba (JP)

Correspondence Address: WENDEROTH, LIND & PONACK L.L.P., 2033 K. STREET, NW, SUITE 800, WASHINGTON, DC, 20006, US

(21) Appl. No.: 10/571,463

(22) PCT Filed: Nov. 15, 2004
(86) PCT No.: PCT/JP04/16954

§ 371 Date: Mar. 13, 2006

(30) Foreign Application Priority Data
Nov. 13, 2003 (JP) 2003-383530

(51) Int. Cl. H04L 9/00

(52) U.S. Cl. 713/172

(57) ABSTRACT

A memory card 13 includes wireless network communication unit for having electronic equipment to access a storage server 11 on a network. The storage server 11 includes at least a non-authentication area 111. Data such as contents is written into a non-authentication area of the memory card 13 or the non-authentication area 111 of the storage server 11. In other words, an area of a storage area to which data can be written is expanded by the non-authentication area 111 of the storage server 11. Thus, the non-authentication area of the memory card 13 increases apparently. Encoding key used for encoding and decoding contents protected by copyrights is written to an authentication area on the memory card 13. Anyone can access content data in the non-authentication area 111 of the storage server 11, but an encoding key required for decoding the content is in the memory card 13. Thus, only a person who has the memory card 13 and valid electronic equipment can decode, reproduce and output the content using the encoding key. In this way, the storage capacity of the memory card 13 can be increased apparently while security of data protected by copyrights is guaranteed.

### TECHNICAL FIELD

The present invention relates mainly to a video audio signal process terminal for recording and reproducing video and audio utilizing networks.

### BACKGROUND ART

Recently, a service of distributing contents such as video and audio utilizing wireless network is becoming more popular as wireless network infrastructure spreads. Contents distributed through wireless networks are received by, for example, terminals having connection functions to wireless networks and stored in recording media. Typical terminals having wireless connection functions are mobile terminals carried along by moving users. Examples of the mobile terminals include cell phones, personal digital assistance (PDA), notebook personal computers (PC) and the like.

Usually, portable recording media such as memory cards are inserted into the mobile terminals, and contents are recorded thereon. However, since a storage capacity of the portable recording media is limited, a large amount of contents with high volume information such as video and audio cannot be recorded. In order to solve this problem, a method of inserting a portable recording medium to a terminal connected to a recording medium with a large capacity such as a hard disc of a PC to use the hard disc as a backup area for contents. In such a case, the portable recording medium has to be used integrally with the terminal. This impairs a convenience in utility as a mobile terminal.

An object of the present invention is to increase a recording capacity of a portable recording medium which can be used by a mobile terminal. Another object of the present invention is to protect contents distributed through wireless networks based on copyrights. Yet another object of the present invention is to provide a portable recording medium which can be used with any type of mobile terminals.

### DISCLOSURE OF THE INVENTION

In order to solve the above-described problems, Invention 1 provides a semiconductor memory card attachable and removable to and from electronic equipment, comprising:
a first rewritable nonvolatile memory;
first access control unit for controlling access by the electronic equipment to the first nonvolatile memory;
communication unit for controlling access by the electronic equipment to a storage device on a network which has a second rewritable nonvolatile memory;
second access control unit for controlling access by the electronic equipment to the second nonvolatile memory; and
space unification unit for forming a virtual unified memory space including the first nonvolatile memory and the second nonvolatile memory.

If the semiconductor card is used, any electronic device can access to a storage device to write and read data. Thus, an apparent storage capacity is increased. Therefore, flexibility of a memory space for recording contents with a large amount of data such as video image data is increased and the convenience for users can be enhanced. The storage device includes a database and a data base management system (DBMS) for managing writing and reading to and from the database.

Invention 2 provides a semiconductor memory card according to Invention 1, further comprising contention determination unit for determining whether data to be accessed by the second access control unit is being written or read by other semiconductor cards, and starting, stopping, or delaying writing and/or reading by the second access control unit based on the determination result.

An editing process is a process for modifying a part of recorded data which already exist, such as changing titles, partially erasing, adjusting brightness, and the like. A recording process is a process for writing new data into a second nonvolatile memory in the storage device. A reproduction process is a process for reading out recorded data which already exist without any modification. By controlling accesses to one content from a plurality of memory cards, target data to be edited can be prevented from being overwritten by access to the storage device from other semiconductor memory cards. It is also possible to prevent target data to be reproduced from being overwritten by access to the storage device from other semiconductor memory cards. Further, when target data to be reproduced is being recorded to the storage device from another semiconductor device, time-shift reproducing of parts which have been already recorded is possible.

Invention 3 provides a semiconductor memory card according to Invention 1, wherein the communication unit stores address of the storage device on the network. The electronic equipment can access the storage device based on stored network address.

Invention 4 provides a semiconductor memory card according to Invention 3, wherein the communication unit accesses the storage device using identification information of the semiconductor memory card. The identification information of the semiconductor memory allows mutual authentication between the storage device and the semiconductor memory card.

Invention 5 provides a semiconductor memory card according to Invention 1, further comprising: encoding unit for generating an encoding key for encoding the data and for encoding the data with the encoding key; and authentication unit for verifying validity of the electronic equipment, wherein: the first nonvolatile memory includes a first authentication area and a first non-authentication area which are predetermined storage areas; the first access unit controls access by the electronic equipment to the first non-authentication area and permits the access by the electronic equipment to the first authentication area when the authentication unit authenticates the validity of the electronic equipment; the second access unit controls access by the electronic equipment to second non-authentication area which is a predetermined storage area included in the second nonvolatile memory; and the space unification unit allocates address of the second non-authentication area in the second nonvolatile memory to the data encoded with the encoding key, and allocates the address of the first authentication area in the first nonvolatile memory to the encoding key.

The encoding key for encoding contents protected by copyrights and the encoded content are stored in different memory areas. Even if the encrypted content is obtained by an unauthorized party, the encoding key is not obtained by the unauthorized party at the same time. Thus, decoding of the encoded content is impossible, and security of the content can be guaranteed.

Invention 6 provides a semiconductor memory card according to Invention 5, wherein the space unification unit determines which of the addresses of the first non-authentication area in the first nonvolatile memory and the second non-authentication area in the second nonvolatile memory is allocated to the data encoded with the encoding key, and allocates the address to the data in accordance with the determination.

A method for determining which of the first non-authentication area and the second non-authentication area is not particularly limited. Which of the methods should be used may be decided in view of convenience for the user and efficiency of the storage areas. For example, the space unification unit may receive an instruction for designating to which of the semiconductor memory card and the storage device the data should be written from the user. In such a case, the space unification unit can determine address of which of the storage areas should be allocated to the encoded data based on the instruction from the user. This is convenient because the user can store the data into whichever useful for oneself. Alternatively, the space unification unit may store to either one preferentially, and, use the other only when there is no enough empty space. For example, the space unification unit may confirm whether there is an enough space in the first non-authentication area in the first nonvolatile memory. In such a case, the space unification unit can determine address of which of the first non-authentication area and the second non-authentication area should be allocated to the encoded data based on the confirmation result. Since the memory area to store the data is selected based on the amount of data, the storage areas can be used efficiently.

Invention 7 provides a semiconductor memory card according to Invention 5, wherein the second access unit permits access by the electronic equipment to the second authentication area which is a predetermined storage area in the second nonvolatile memory when the authentication unit authenticates validity of the electronic equipment.

Providing the second authentication area in the storage devices apparently increases the first authentication area in the semiconductor memory card. Thus, even when data such as content is stored in the first or second authentication areas without encoding, the storage areas can be sufficiently prepared and the security of the content can be guaranteed at the same time.

Invention 8 provides a semiconductor memory card according to Invention 1, wherein: the first nonvolatile memory includes a management area; the space unification unit allocates address in the first nonvolatile memory or the second nonvolatile memory to data, and writes data identifier for identifying the data into the management area with being associated with the allocated address; the first access unit and the second access unit receives a request for writing the data to the first nonvolatile memory or the second nonvolatile memory, and write the data to a storage area corresponding to the address allocated to the data.

The management area corresponds to so-called FAT. The FAT in the first nonvolatile memory manages addresses of the first authentication area and the first non-authentication area in the first nonvolatile memory and address of the second non-authentication area of the second nonvolatile memory. For example, the space unification unit allocates address 0000-3FFF to the first authentication area and the second non-authentication area, and allocates address 4000-FFFF to the second non-authentication area. Identifiers of data to be written into the first authentication area, the first non-authentication area and the second non-authentication area are stored in the FAT with being associated with one of the addresses managed by the space unification unit. In this way, the space unification unit can form a virtual unified memory space.

Invention 9 provides a semiconductor memory card according to Invention 8, wherein the second access unit receives a request for reading data, reads address of the second nonvolatile memory on which the data is written from the management area, and accesses the read out address via the communication unit to read out the data.

When a reading out request is received from a user of the electronic equipment, the second access unit accesses the address corresponding to the data identifier if the data is stored in the second non-authentication area, and reads out the data from the second non-authentication area. In this way, user can read out data such as contents not only from the semiconductor memory card but also the storage device as long as the semiconductor memory card can be used.

Invention 10 provides a semiconductor memory card according to Invention 8, further comprising encoding unit for generating an encoding key for encoding or decoding the data and for encoding the data with the encoding key, wherein: the second access unit reads out address of the second non-authentication area on which the data encoded with the encoding key is written from the management area, and accesses the address of the second non-authentication area to read out the encoded data via the communication unit; and the first access unit reads out address of the first non-authentication area on which the encoding key is written from the management area, and accesses the address of the first non-authentication area to read out the encoding key.

The encoding key for encoding contents protected by copyrights and the encoded content are stored in different memory areas. Although the encrypted content is obtained by an unauthorized party, the encoding key is not obtained by the unauthorized party at the same time. Thus, decoding of the encoded content is impossible, and security of the content can be guaranteed.

Invention 11 provides a memory space management method, comprising:
a first access control step for controlling access by electronic equipment to a first rewritable nonvolatile memory;
a communication step for controlling access by the electronic equipment to a storage device on a network which has a second rewritable nonvolatile memory;
a second access control step for controlling access by electronic equipment to the second nonvolatile memory; and
a space unification step for forming a virtual unified memory space including the first nonvolatile memory and the second nonvolatile memory.

This method has similar functions and effects as Invention 1.

Invention 12 provides a memory space management program which is recorded on a semiconductor memory card which is attachable and removable to and from electronic equipment and includes a computer, causing the computer to function as: first access control unit for controlling access by electronic equipment to a first rewritable nonvolatile memory; communication unit for controlling access by the electronic equipment to a storage device on a network which has a second rewritable nonvolatile memory; second access control unit for controlling access by electronic equipment to the second nonvolatile memory; and space unification unit for forming a virtual unified memory space including the first nonvolatile memory and the second nonvolatile memory.

This program has similar functions and effects as Invention 1. Computer readable recording media on which such a program is recorded is also within the scope of the present invention. The recording media may be a computer readable flexible disc, a hard disc, a semiconductor memory, a CD-ROM, a DVD, a magneto-optical disc (MO), or the like. The programs include programs stored in the recording media and programs which can be downloaded.

### BRIEF DESCRIPTION OF THE DRAWINGS

FIG. 1 shows a system including a terminal with a memory card inserted therein.

FIG. 2 is a schematic block diagram showing the memory card.

FIG. 3 shows exemplary connection information stored in an NV-RAM.

FIG. 4 is a schematic diagram illustrating list data.

FIG. 5 shows an exemplary list display screen for recorded programs which is displayed based on the list data of FIG. 4.

FIG. 6 is a schematic diagram illustrating information to be recorded in a FAT written by a space unification section.

FIG. 7 is a schematic diagram illustrating address conversion performed by the space unification section.

FIG. 8 is a block diagram of a terminal.

FIG. 9 is a flow diagram showing an exemplary flow of a connecting process.

FIG. 10A is a flow diagram showing an exemplary flow of a writing process.

FIG. 10B is a flow diagram showing an exemplary flow of a part of the writing process which is performed by the memory card.

FIG. 11 is a flow diagram showing an exemplary flow of a list outputting process.

FIG. 12 is a flow diagram showing an exemplary flow of a reading process.

FIG. 13 is a flow diagram showing an exemplary flow of an exclusive control process.

FIG. 14 shows an exemplary program list display screen when there is access right management.

FIG. 15 shows exemplary data of an access right management table stored in a storage server.

FIG. 16 shows an exemplary screen for producing memory cards which can access the storage server with different access rights.

### BEST MODE FOR CARRYING OUT THE INVENTION

### Summary of Invention

A semiconductor memory card (hereinafter, simply referred to as a memory card) according to the present invention is inserted into electronic equipment and data is written to or read out from the memory card. The memory card has an authentication area where authentication of electronic equipment which writes and/or reads data is required (corresponding to a first authentication area) and a non-authentication area where authentication is not required (corresponding to a first non-authentication area). The memory card according to the present invention includes wireless network connection unit for having the electronic equipment to access a storage server (corresponding to storage device) on a network. The storage server includes at least a non-authentication area (corresponding to a second non-authentication area).

Data such as contents is written to the non-authentication area of the memory card or the non-authentication area of the storage server. In other words, an area of a storage area to which data can be written is expanded by the non-authentication area of the storage server. Thus, the non-authentication area of the memory card apparently increases.

An encoding key used for encoding and decoding contents protected by copyrights is written into the authentication area on the memory card. Although anyone can access the content data in the non-authentication area on the storage server, an encoding key which is necessary for decoding the content is on the memory card. Thus, only a person who has the memory card and valid electronic equipment can decode, reproduce and output the content using the encoding key. In this way, the storage capacity of the memory card can be increased apparently while security of data protected by copyrights is guaranteed at the same time.

### Embodiment 1

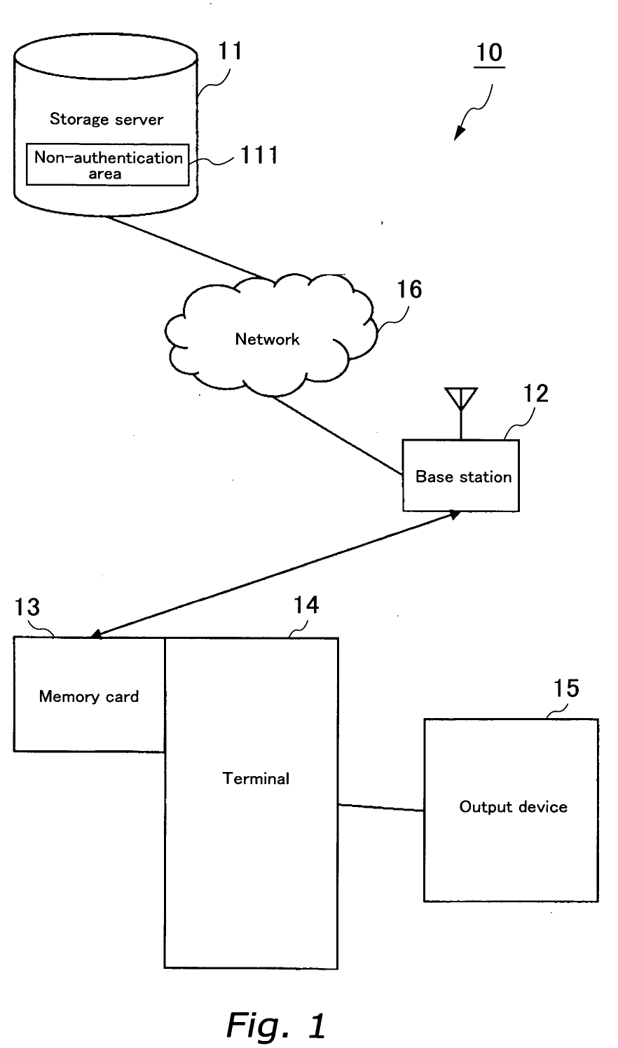

FIG. 1 shows an example of a system 10 including a terminal 14 to which a memory card 13 according to the present invention is inserted. The system 10 includes a storage server 11, a base station 12 of a wireless network, the memory card 13, the terminal 14 (corresponding to electronic equipment) to which the memory card 13 is inserted, and an output device 15. The output device 15 is a speaker or a display for outputting audio and video. The storage server 11 and the base station 12 are connected by a network 106. The base station 12 and the memory card 13 can be connected by a wireless network. Hereinafter, the structure of the memory card 13 and the storage server 11 will be described in more detail.

[Memory Card]

(1) Entire Structure

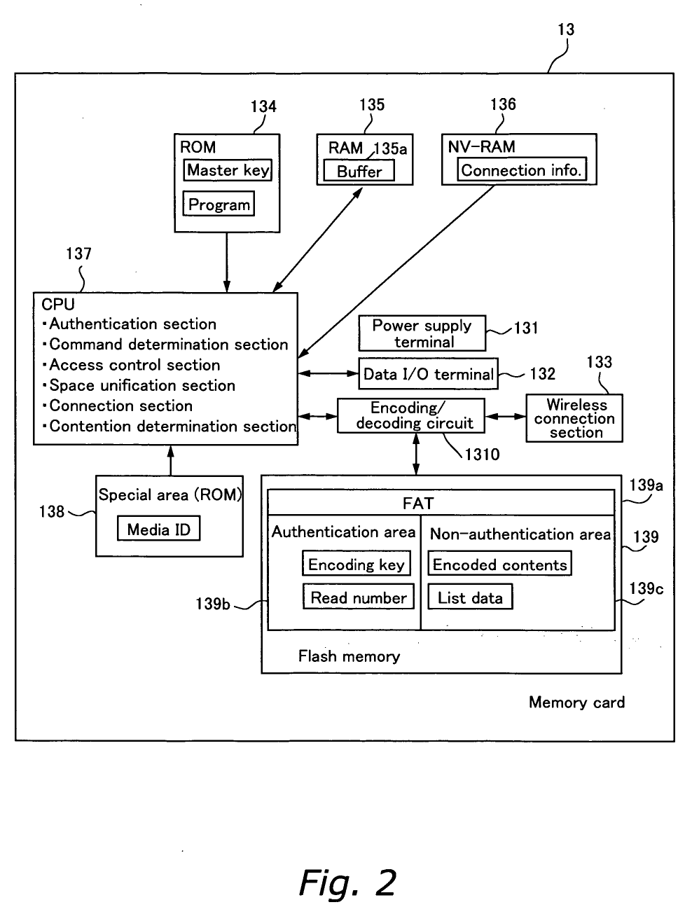

FIG. 2 is a block diagram showing a schematic structure of the memory card 13. The memory card 13 receives a power supply and a supply of a clock signal from outside via a power supply terminal 131 to operate. The memory card 13 is also electrically connected to external equipment such as the terminal 14 by a data I/O terminal 132. The memory card 13 further includes following elements (a) through (h).

(a) Wireless Communication Section (Corresponding to Communication Unit)

A wireless communication section 133 connects the memory card 13 and the network 106 via the base station 12. Connection information stored in an NV-RAM 136, which will be described below, is used for connection.

(b) ROM

A ROM 134 stores a master key and programs. The programs are executed by a CPU 137, which will be described below, to achieve various functions. The master key is used for mutual authentication with the terminal 14 and the storage server 11. The master key is also used for protection of data in a flash memory 139 and the storage server 11.

(c) RAM

A RAM 135 is used as a working area for a process by the CPU 137.

(d) NV-RAM

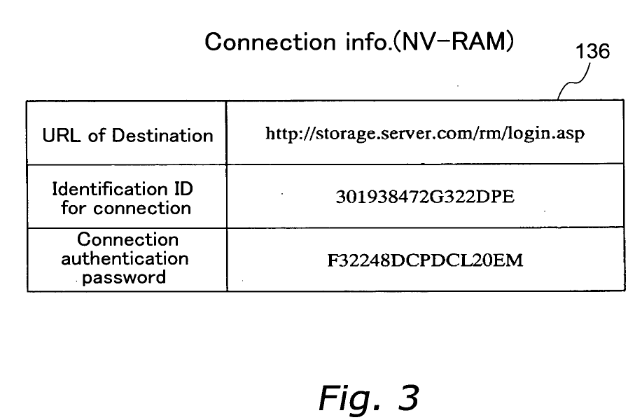

The NV-RAM 136 is a nonvolatile memory which stores connection information necessary for connection to the storage server 11. The connection information may be, for example, a network address of the storage server 11. FIG. 3 shows an example of connection information stored in the NV-RAM 136. In this example, URL of the storage server 11, an identification ID for connection, and connection authentication password are included in the connection information. The identification ID for connection and the connection authentication password are identification information for identifying the memory card 13.

(e) CPU

The CPU 137 executes programs stored in the ROM 134 to achieve various functions.

(f) Special Area (ROM)

A special area 138 previously stores a media ID which is identification information unique to the memory card 13 and information such as name of the manufacturer of the memory card 13 and the like. The media ID is a unique identifier which enables to distinguish the memory card 13 from other semiconductor memory cards 13. In the present embodiment, the media ID is used for mutual authentication between equipment and is used for preventing unauthorized access to an authentication area and unlawful access to the storage server 11.

(g) Flash Memory (Corresponding to a First Nonvolatile Memory)

A flash memory 139 is a rewritable nonvolatile memory which can be overwritten for many times. The flash memory 139 includes logical storage areas such as a FAT (corresponding to a management area) 139a, an authentication area (corresponding to a first authentication area) 139b, and a non-authentication area (corresponding to a first non-authentication area) 139c. The authentication area 139b is a storage area to which only terminals 14 authenticated as valid equipment can access. The non-authentication area 139c is a storage area to which terminals 14 can access without such an authentication. The FAT 139a is a storage area for a unified management of a memory space including storage areas in the flash memory 139 and the storage server 11.

The authentication area 139b is used for storing data important for protecting copyrights. Data can be written to and read out from the authentication area 139b only when authentication is succeeded between the terminal 14 and the memory card 13. For accessing the authentication area 139b, encoded commands are used. The authentication area 139b stores, for example, an encoding key obtained by encoding a password and a readout number. The password is used for encoding data protected by copyrights. The readout number indicates the number of times the data can be reproduced or digitally output. Although it is not shown, the encoding key and the readout number are stored with being associated with data ID and can be searched by using the data ID as a key.

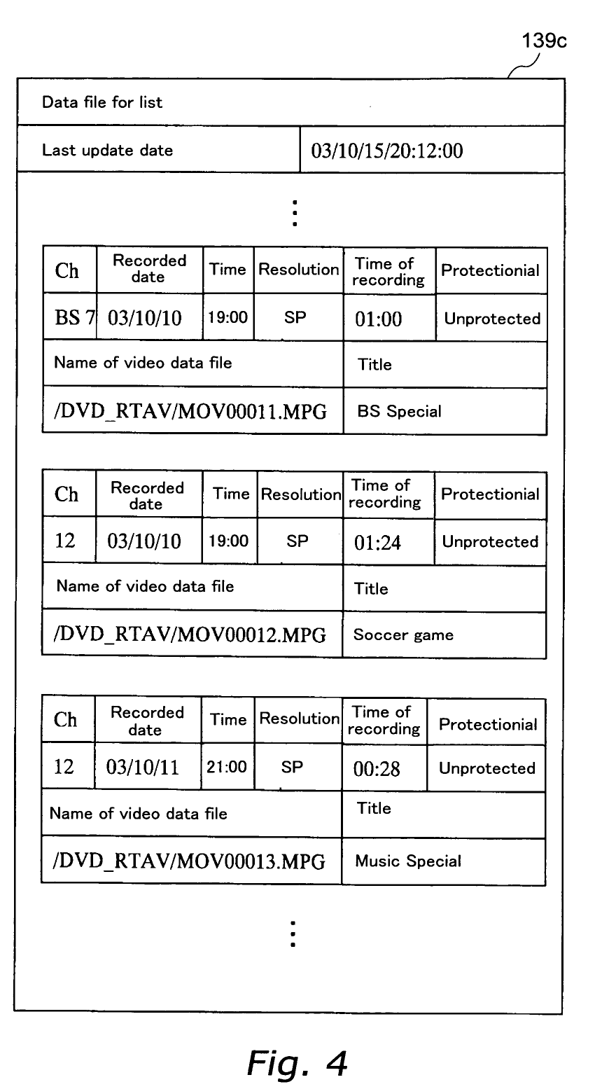

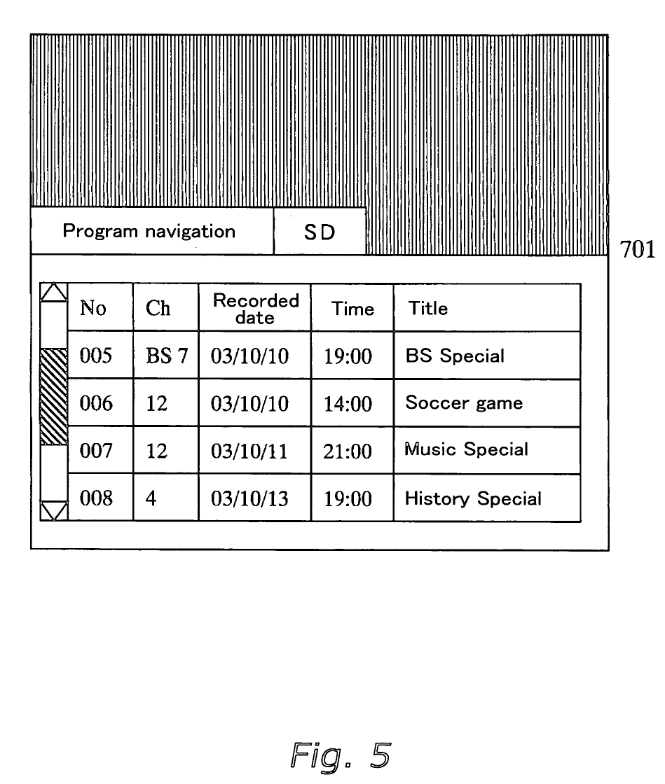

The non-authentication area 139c is used as a supplementary memory device in a typical computer system. The non-authentication area 139c is an area which can be accessed with published commands such as ATA, SCSI or the like, i.e., an area from and to which data can be read and written without authentication. Therefore, data can be written to or read from the non-authentication area 139c by a file management software on the terminal 14 as in flash ATA or compact flash (R). The non-authentication area 139c stores, for example, encoded contents encoded with the password and/or list data. FIG. 4 is a schematic diagram of list data. In this figure, list data for outputting a list of recorded programs is shown as an example. FIG. 5 shows an example of a display screen showing a list of recorded programs which is displayed based on the list data shown in FIG. 4. The screen receives a request for reading any program.

These are merely example of information recorded in the authentication area 139b and the non-authentication area 139c, and the stored information is not limited to these examples.

(h) Encoding/Decoding Circuit

An encoding/decoding circuit 1310 is a control circuit for encoding and decoding data. The encoding/decoding circuit 1310 encodes data when it writes the data into the flash memory 139 and decodes the data when it reads the data from the flash memory 139. This is for preventing corrupt actions by an unauthorized user such as disassembling the memory card 13, directly analyzing contents of the flash memory 139, and stealing the encoding key stored in the authentication area.

(2) Functions of CPU

The programs stored in the ROM 134 cause the CPU 137 to achieve the following functions. In the present embodiment, the following functions are realized by the programs. However, the following functions may be realized by hardware, for example, control circuits made of active elements.

(2-1) Authentication Section

An authentication program stored in the ROM 134 causes the CPU 137 of the memory card 13 to function as an authentication section (corresponding to authentication unit). The authentication section performs mutual authentication of a challenge and response type with a terminal 14 trying to access the memory card 13. The authentication section has a random number generation program, encoding program, or the like. The authentication section verifies validity of the terminal 14 by detecting whether the terminal 14 has an encoding program same as that of the authentication section. The mutual authentication of a challenge and response type is an authentication method in which both of the devices perform an authentication step such as determining whether the terminal 14 is authenticated or not by comparing challenge data sent from the memory card 13 to the terminal 14 and response data sent from the terminal 14 to the memory card 13. In the authentication step, the memory card 13 sends challenge data for verifying the validity of the terminal 14 to the terminal 14. In response, the terminal 14 generates response data with a process for certifying its validity and sends it to the memory card 13.

(2-2) Command Determination Section

A command determination program stored in the ROM 134 causes the CPU 137 of the memory card 13 to function as a command determination section. The command determination section determines the type of commands which are instructions to the memory card 13. The commands include commands for reading, writing or erasing data of the flash memory 139 and the storage server 11. Such a command is input via the data I/O terminal 132. In accordance with the type of the input command, the functional sections which will be described below operate.

(2-3) Access Control Section

An access control program stored in the ROM 134 causes the CPU 137 of the memory card 13 to function as an access control section (corresponding to the first access unit and the second access unit). The access control section respectively operates writing and reading of data to and from the authentication area 139b and the non-authentication area 139c of the flash memory 139. Only a request for writing to or reading from the authentication area 139b from the terminal 14 authenticated by the authentication is permitted.

The access control section further operates writing and reading of data to and from a non-authentication area (corresponding to the second non-authentication area) 111 of the storage server 11 which will be described below. Specific methods for writing and reading may be as follows. An example where the storage server 11 and the wireless communication section 133 are communicative via HTTP (Hyper Text Transfer Protocol) is considered. For reading, the access control section utilizes GET command and RANGE specifier via the wireless communication section 133 to read out data from the specified address on the storage server 11. For writing, the access control section utilizes PUSH command/POST command and RANGE specifier to write data to the specified address on the storage server 11. Of course, communication between the storage server 11 and the wireless communication section 133 is not limited to HTTP. Other types of communication protocols, for example, FTP (File Transfer Protocol) may also be used.

The data writing process includes a recording process and an editing process. The data reading process includes a reproducing process and a time-shift reproducing process. The recording process is a process of writing new data to storage areas. The editing process is a process of modifying part of data which already exist, such as, changing titles, partial erasing, adjusting brightness, or the like. The reproducing process is a process of outputting data which already exist without any modification. The time-shift reproducing process is a process of outputting data which already exist without any change within the range that writing address for the data does not exceed reading address for the data. The reading process of data may also include digital output of the data, for example, copying, moving, and the like.

(2-4) Space Unification Section

A space unification program stored in the ROM 134 causes the CPU 137 of the memory card 13 to function as a space unification section (corresponding to space unification unit). The space unification section forms a virtual unified memory space including the authentication area 139b and the non-authentication area 139c of the flash memory 139 and the non-authentication area 111 of the storage server 11.

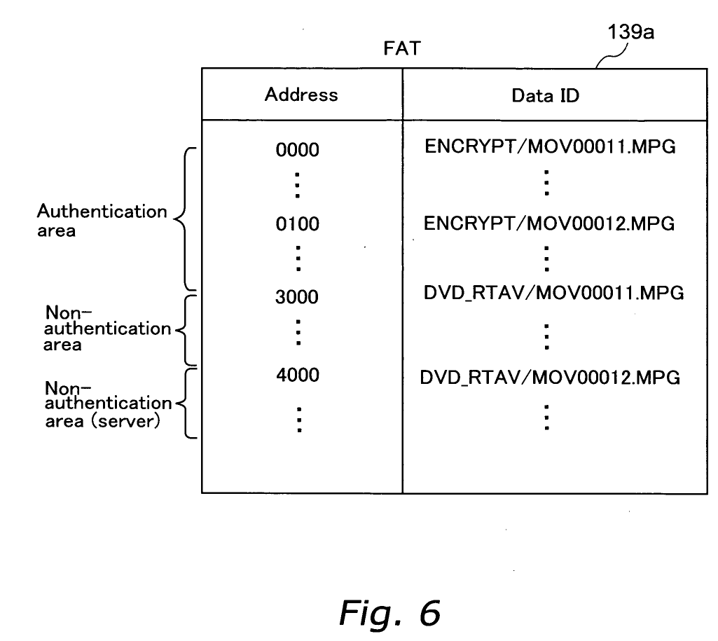

FIG. 6 is a schematic diagram illustrating information recorded in the FAT 139a to which the space unification section writes the information. The FAT 139a is a recording area for address management in the flash memory 139. The FAT 139a stores addresses of the authentication area 139b and the non-authentication area 139c of the flash memory 139 and an address of the non-authentication area 111 of the storage server 11. In other words, the FAT 139a stores an address of the virtual unified memory space. An identifier of data written into any of the storage area is stored in the FAT with being associated with the address to which the data has been written. For example, data ID “ENCRYPT/MOV00011.MPG” is stored with being associated with address 0000-0099. This means that the content specified by the data ID is stored at address 0000-0099.

In this example, the space unification section allocates address 0000-3999 to the authentication area 139b and the non-authentication area 139c of the flash memory 139, and address 4000-9999 to the non-authentication area 111 of the storage server 11. Positions of borders of the storage areas 139b, 139c, and 111 are written into a buffer which is not shown by the space unification section. The positions of the borders may be fixed, or may be variable. In this figure, data identified by “ENCRYPT/MOV00011.MPG” and “ENCRYPT/MOV00012.MPG” are stored in the authentication area 139b. Data identified by “DVD#RTAV/MOV00011.MPG” is stored in the non-authentication area 139c. Data identified by “DVD#RTAV/MOV00012.MPG” is stored in the non-authentication area 111 of the storage server 11.

When data is read out in response to a reading request from the terminal 14, the space management section determines in which of the flash memory 139 and the storage server 11 the data is stored with reference to the FAT 139a, and passes the determination result and the address to the access control section.

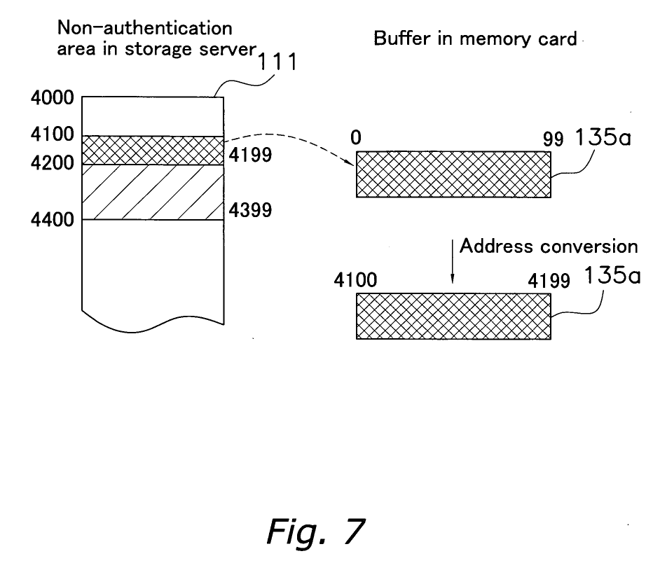

FIG. 7 is a schematic diagram illustrating address conversion performed by the space unification section. Address conversion is necessary when data is written to and read from the storage server 11 in order to pretend that the non-authentication area 111 of the storage server 11 is being accessed. Writing and reading is performed using the buffer 135a in the RAM 135 as a working area. This figure illustrates address conversion when a data file of 399 Mbytes which is stored in address 4000-4399 in the non-authentication area 111 of the storage server 11 is read out. The buffer can store data at the maximum of 100 Mbytes. Address of 0-99 is allocated to the buffer. The data file is temporarily stored in the buffer in the RAM 135 by, for example, 100 Mbytes. When 100 Mbytes of a header of the data file are written into the buffer, the space unification section converts the address of the buffer from 0-99 to 4000-4099. The address and the data are returned to the terminal 14. When next 100 Mbytes are written, the space unification section converts the address of the buffer to 4100-4199, and the access control section returns the address and the data to the terminal 14. Such a process is repeated until it reaches to an end of the data file. In this way, it seems that address 4000-4399 is accessed on the terminal 14 side. For writing data into the storage server 11, an opposite process is performed.

As described above, collective management of the storage areas in the flash memory 139 and the storage server 11 allows forming a virtual unified memory space and apparently increasing the storage capacity. Usually, contents protected by copyrights are stored in the authentication area 139b of the flash memory 139 after encoding. This means that providing the non-authentication area 111 in the storage server 11 allows apparently increasing a storage capacity of the flash memory 139. Therefore, flexibleness of the memory space for recording contents with a large amount of data such as video image data is increased to enhance convenience for the user.

(2-5) Connection Section

A connection program stored in the ROM 134 cause the CPU 137 of the memory card 13 to function as a connection section (corresponding to a part of the communication unit). The connection section uses the connection information stored in the NV-RAM 136 to make a connection to the storage server 11 via the wireless communication section 133.

(2-6) Contention Determination Section

A contention determination program stored in the ROM 134 causes the CPU 137 of the memory card 13 to function as a contention determination section (corresponding to the first, second, and third contention determination unit). The contention determination section prevents inconsistency when other memory cards 13 are accessing the same object for access. Specifically, the contention determination section imposes a restriction to a certain extent on writing if target data to be written is also a target for writing by other memory cards 13. The contention determination section also imposes a restriction to a certain extent on reading if target data to be read out is an object for writing by other memory cards 13.

[Terminal]

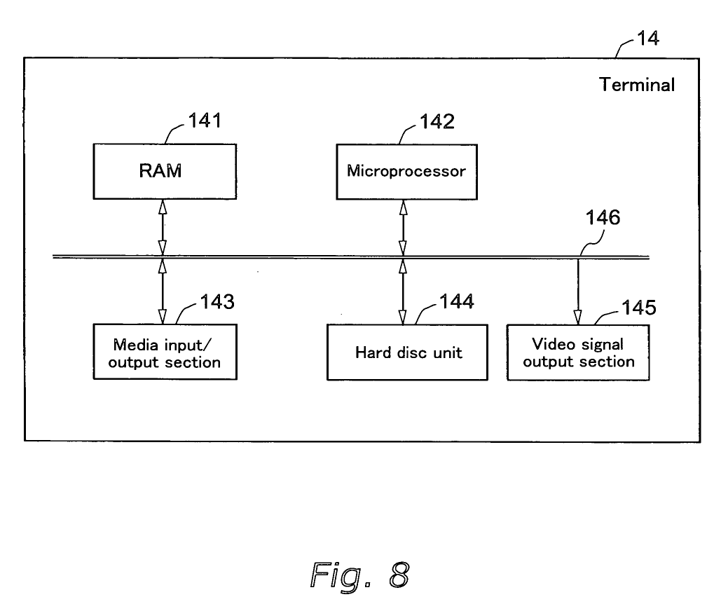

FIG. 8 is a block diagram of the terminal 14. The terminal 14 is formed of a RAM 141, a microprocessor 142, a medium input/output section 143, a hard disc unit 144, and a video signal output section 145 connected to each other via an internal bus 146. The hard disc unit 144 stores programs. The microprocessor 142 operates in accordance with the programs, and thus, each of processing sections forming the terminal 14 can achieve its function. The non-authentication area 111 is formed at the hard disc unit 144. The non-authentication area 111 stores program data, list data or the like similarly to the non-authentication area 139c on the flash memory 139.

[Process]

Next, processes by the memory card 13 and the terminal 14 with the memory card 13 being inserted therein will be described specifically with reference to the drawings. The processes can be broadly groped into: (1) a connecting process; (2) a writing process; (3) a list outputting process; (4) a reading process; and (5) an exclusive control process. Hereinafter, these five types of processes will be described respectively. In the description below, writing or reading program data protected by copyrights (hereinafter, referred to as contents), or a list-outputting process accompanied with the reading process will be described as an example. In FIGS. 8 through 12 referred in the description below, the memory card 13 may be abbreviated as RM.

(1) Connecting Process

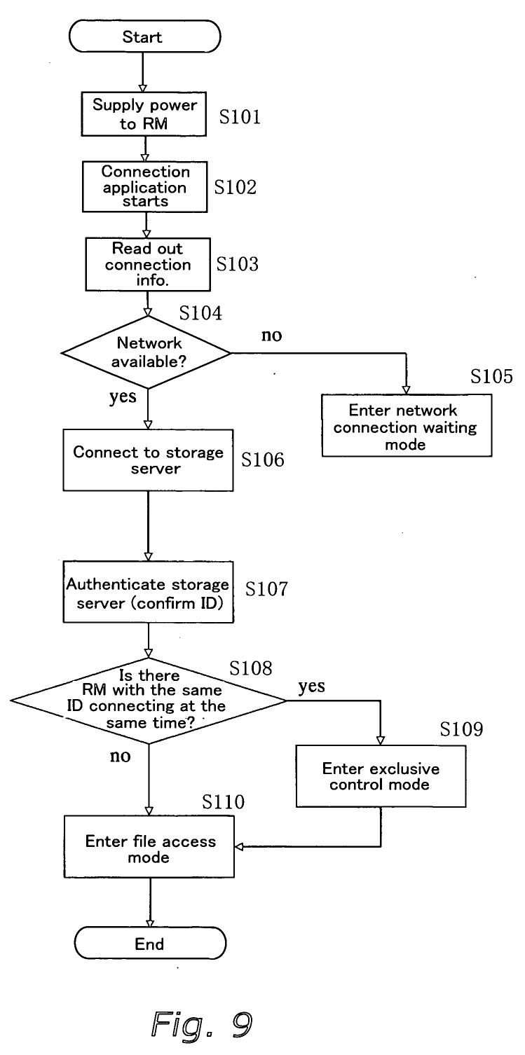

FIG. 9 is a flow diagram showing an exemplary flow of a connecting process operated when the memory card 13 is inserted into the terminal 14. With the following process, the memory card 13 tries to connect to a network via the base station 12. The following process is started by inserting the memory card 13 into the terminal 14.

Step S101: Power is supplied to the memory card 13 from outside via the power supply terminal 131.

Steps S102 and S103: Upon supply of power, the connection program stored in the ROM 134 is read to the CPU 137 and is started (S102). The CPU 137 functioning as the connection section reads out the connection information stored in the NV-RAM 136 (S103), and tries to connect to the storage server 11 via the wireless communication section 133.

Steps S104 and S105: The connection section of the CPU 137 determines whether the wireless network is available or not (S104). When the network is not available, the connection section enters “network connection waiting mode” (S105). When the connection section is in the network connection waiting mode, it intermittently checks in a certain period whether the wireless network becomes available. While waiting, the connection section accesses contents in the storage server 11, only the contents in the storage server 11 which have been already downloaded to the RAM 135.

Step S106: When the wireless network is available, the connection section connects to the storage server 11 via the wireless communication section 133.

Step S107: The connection section further performs authentication with the storage server 11 using the connection information, and establishes connection.

Steps S108 and S109: The connection section determines whether there is any other memory card 13 accessing the storage server 11 at the same time. The determination may be made based on a response to an inquiry to the storage server 11 asking the number of connections at the same time. If there is asynchronous access by another memory card 13 at the same time, the connection section enters an exclusive control mode in order to avoid inconsistency due to asynchronous access (S109). Specifically, the connection section sets a recording process permission flag and an editing process permission flag respectively indicating that recording and editing are possible to “OFF”. The connection section further sets a reproducing process permission flag and a time-shift reproducing process permission flag respectively indicating that reproducing and time-shift reproducing are possible to “OFF”.

Step S110: The connection section sets a file access mode if there is no other memory card 13 accessing the storage server 11 (S110). Specifically, the connection section sets the recording process permission flag and the editing process permission flag respectively indicating that recording and editing are possible to “ON”. The connection section further sets the reproducing process permission flag and the time-shift reproducing process permission flag respectively indicating that reproducing and time-shift reproducing are possible to “ON”.

With the above-described processes, connection between the memory card 13 and the storage server 11 can be established. If there is a contending memory card 13, the memory card 13 can know that which of the processes is contending.

(2) Writing Process

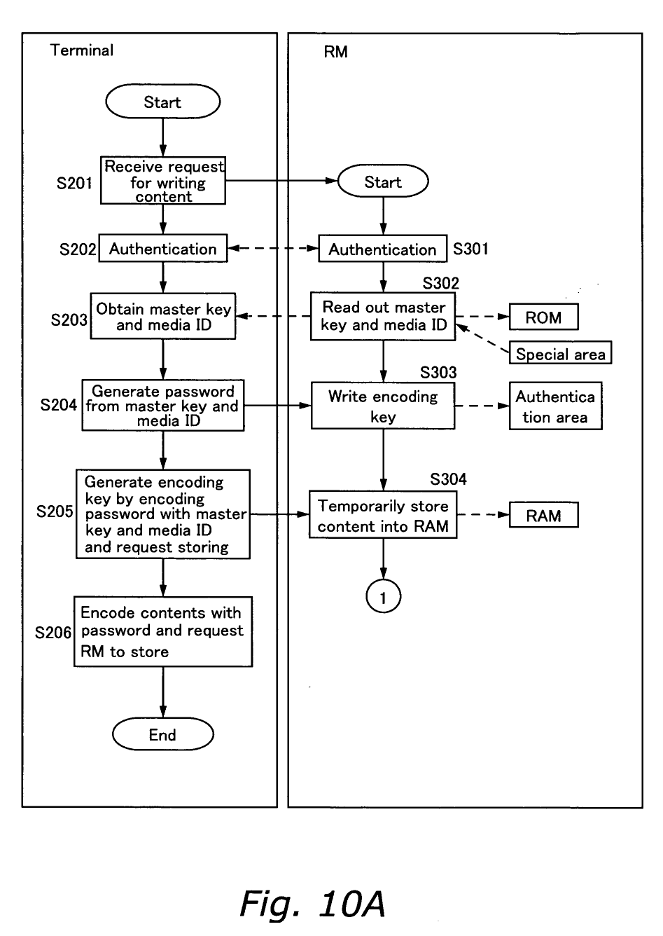

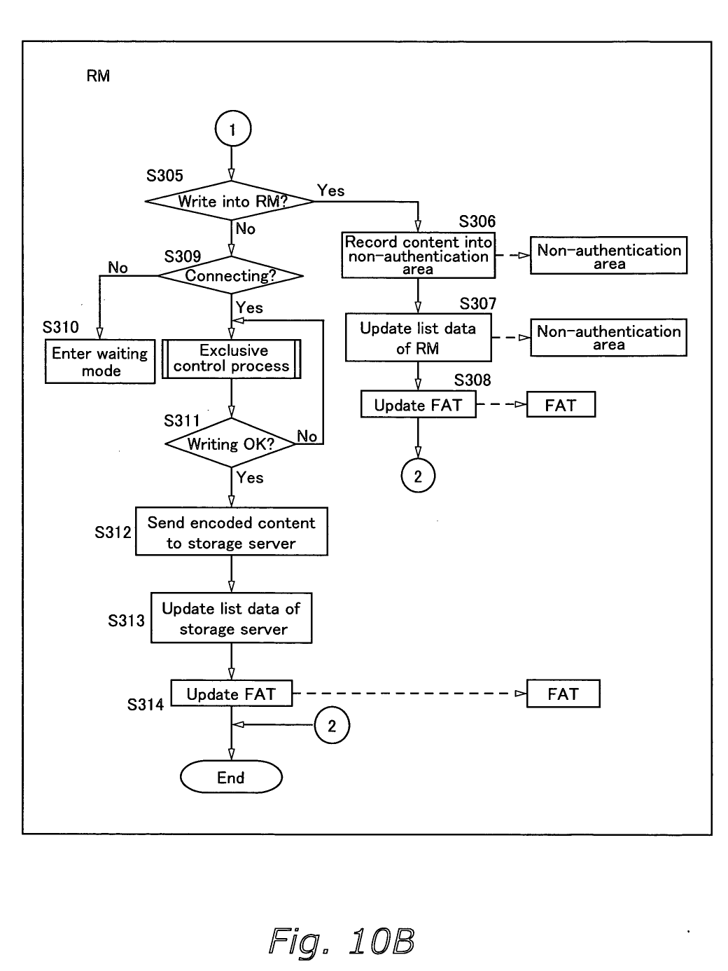

FIGS. 10A and 10B are flow diagrams showing an exemplary flow of processes performed by the terminal 14 and the memory card 13 when the terminal 14 writes content to the memory card 13.

(2-1) Processes by Terminal

When a user of the terminal 14 instructs writing data by pressing a predetermined button on the screen or the like, the following process is started at the terminal 14. In the following process, the terminal 14 issues a request for writing content to the memory card 13.

Step S201: The microprocessor 142 of the terminal 14 receives a writing request by pressing a predetermined button on the screen or the like.

Step S202: The microprocessor 142 of the terminal 14 performs authentication of a challenge and response type with an authentication program of the memory card 13.

Step S203: When the authentication process with the memory card 13 succeeds, the microprocessor 142 of the terminal 14 requests reading of the master key and the media ID to the memory card 13 and obtains them.

Step S204: The microprocessor 142 of the terminal 14 generates a random number and generates a password for encoding the content from the master key and the media ID obtained from the memory card 13 and the generated random number. The random number is obtained by, for example, encoding challenge data (random number) sent to the memory card 13 in the authentication.

Step S205: The microprocessor 142 of the terminal 14 encodes the obtained password with the master key and the media ID to generate an encoding key. The microprocessor 142 further requests the memory card 13 to write the generated encoding key into the authentication area 139b and stores the encoding key into the authentication area 139b. The request is issued by encoding and sending a command for writing into the authentication area 139b to the memory card 13 before sending the encoding key.

Step S206: The microprocessor 142 of the terminal 14 passes the encoded content to the memory card 13 as it encodes the content using the password, and requests writing.

The above writing process at the terminal 14 side is same for the case where non-authentication area 111 is not provided on the storage server 11.

(2-2) Processes by Memory Card

With reference to FIG. 10 again, an exemplary flow of a writing process by the memory card 13 will be described. In this process, content is written into the memory card 13 or the storage server 11 in response to the writing request from the terminal 14. When the request for writing content is received from the terminal 14, the following process is started. The following process can be broadly divided into: preprocessing; writing into the memory card; and writing into the storage server.

(2-2-1) Preprocessing

Step S301: The authentication section of the CPU 137 performs authentication of the challenge and response type with the terminal 14.

Step S302: The access control section of the CPU 137 reads out the master key and media ID respectively from the ROM 134 and the special area 138 in response to the reading request from the terminal 14, and passes them to the terminal 14.

Step S303: If the authentication with the terminal 14 has been succeeded in the authentication process described above, the access control section of the CPU 137 writes the encoding key into the authentication area 139b in response to the writing request from the terminal 14.

Step S304: In response to the writing request from the terminal 14, the access control section of the CPU 137 receives the encoded content and temporarily stores into the RAM 135.

(2-2-2) Writing into Memory Card

Step S305: The space unification section of the CPU 137 determines to which of the non-authentication area 139c of the memory card 13 and the non-authentication area 111 of the storage server 11 the encoded content should be written. When the content is written into the memory card 13, the process moves to step S306. When the content is written into the storage server 11, the process moves to step S309.

A method for determining is not particularly limited, but examples are as follows. For example, the user of the terminal 14 may send an instruction for designating to which the content should be written, and the content is written in accordance with the instruction. This is convenient because the user can store the data into whichever useful for oneself.

Alternatively, either one may be set as a preferential destination of writing, and, only when there is no enough empty space for storing the content in the preferential writing destination, the encoded content may be written into the other non-authentication area. In such a case, the space unification section compares data amounts of the encoded contents respectively stored in the FAT 139a and the RAM 135 and confirms presence of an empty space before it determines a writing destination. Which of the memory card 13 and the storage server 11 should be the preferential writing destination may be determined previously or may be set by the user.

Further, the non-authentication area where a proportion of an amount of data to the total empty space will be smaller than that of the other one may be set as the writing destination. Since the place to store the data is selected based on the amount of data, the storage areas can be used efficiently.

The above methods and other methods may be combined appropriately for determining the writing destination. Which of the methods should be used may be decided in view of convenience for the user and efficiency of the storage areas.

Steps S306 through S308: The access control section of the CPU 137 writes the encoded content to the non-authentication area 139c on the memory card 13 (S306). Further, a record for the newly written content is added to the list data in the non-authentication area 139c (S307). At last, the access control section updates the FAT 139a of the flash memory 139. Specifically, the access control section writes the data ID of the encoded content into the FAT 139a with being associated with the address to which the content is written and finishes the process (S308).

(2-2-3) Writing into Storage Server

Step S309 and S310: When it is determined that the encoded content is written into the storage server 11, the access control section determines whether there is a connection to the storage server 11 or not. If there is a connection, the process moves to step S311. If there is no connection, the access control section enters a network connection waiting mode. If a connection between the memory card 13 and the storage server 11 is established in the network connection waiting mode, the process moves to step S311.

Step S311: The access control section of the CPU 137 performs an exclusive control process which will be described below. Based on the result, the access control section determines whether writing to the storage server 11 is permitted or not. The determination is made based on whether the recording process permission flag or the editing process permission flag is switched ON/OFF by the exclusive control process. If the permission flag for the process to be performed is OFF, the access control section waits until it becomes ON. Alternatively, the access control section may notify the user that the designated writing process is impossible and finish the process without waiting.

Step S312: The access control section of the CPU 137 writes the encoded content into the non-authentication area 111 of the storage server 11 via the encoding/decoding circuit 1310 and the wireless communication section 133. Before writing, the space unification section designates the access control section the URL of the storage server 11, and to which of the addresses of the non-authentication area 111 the encoded content should be written. The access control section uses, for example, the URL in the connection information, “PUSH” command or “POST” command of HTTP, and RANGE specifier to write the encoded content to the designated address.

Step S313: The access control section of the CPU 137 adds record regarding the newly written content to the list data in the non-authentication area 111 of the storage server 11 via the encoding/decoding circuit 1310 and the wireless communication section 133. Before adding, the space unification section designates the access control section to which of the addresses of the non-authentication area 111 the new record should be written.

Step S314: The space unification section of the CPU 137 updates the FAT 139a in the memory card 13 after writing by the access control section has succeeded. In this way, the data ID of the content written into the non-authentication area 111 of the storage server 11 and the list data are stored in the FAT 139a with being associated with the address in the non-authentication area 111.

With the above-described process, the memory space of the flash memory 139 in the memory card 13 can be expanded without modifying the writing process by the terminal 14. Further, in the case where content is written into the storage server 11, an encoding key and encoded content are stored in different memory areas. Thus, even when the encoded content is obtained by an unauthorized party, the encoding key is not obtained by the unauthorized party at the same time. Thus, the decoding of the encoded content is impossible. In this way, security of the content can be guaranteed.

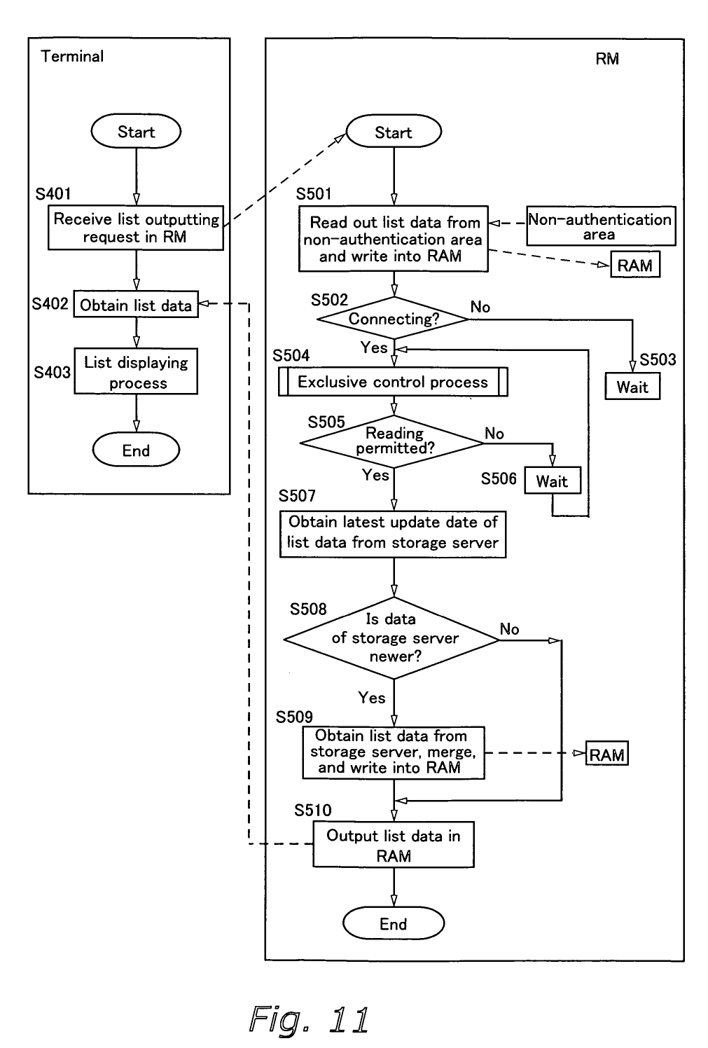

(3) List outputting processes FIG. 11 is a flow diagram showing an exemplary flow of processes by the terminal 14 and the memory card 13 in a list outputting process. The list outputting process is a process for displaying a list of summary of contents before reading out contents to receive designation of content by a user.

(3-1) Process by Terminal

A list outputting process by the terminal 14 will be explained first. The terminal 14 requests list data to the memory card 13 and shows a display based on the list data. When a list outputting request is generated by, for example, a user pressing a button on the screen, the following process is started.

Step S401: The microprocessor 142 of the terminal 14 requests list data to the memory card 13 in response to a request from a user.

Step S402: The microprocessor 142 of the terminal 14 obtains the list data from the memory card 13 in response to the request.

Step S403: The microprocessor 142 of the terminal 14 outputs the list data to the output device 15 such as a display. In this way, the screen as illustrated in FIG. 5 is displayed on the output device 15.

(3-2) Process by Memory Card

Next, a list outputting process by the memory card 13 will be explained. The memory card 13 performs a process of reading out list data from the memory card 13 or the storage server 11 and outputting to the terminal 14 in response to the list outputting request from the terminal 14. When the list outputting request is received from the terminal 14, the following process is started.

Step S501: The access control section of the CPU 137 reads out list data from the non-authentication area 139c in the memory card 13 and temporarily stores in the RAM 135.

Steps S502 and S503: The access control section of the CPU 137 determines whether there is a connection to the storage server 11 (S502). When there is no connection, the access control section enters the network connection waiting mode (S503). When the connection between the memory card 13 and the storage server 11 is established during the network connection waiting mode, the process moves to step S504.

Steps S504 through S506: The access control section of the CPU 137 performs an exclusive control process which will be described below (S504), and determines whether the list data can be read out from the storage server 11 or not based on the result (S505). The determination is made based on whether either the reproducing process permission flag or the time-shift reproducing process permission flag is switched ON in the exclusive control process. If both of the permission flags are OFF, the access control section waits until one becomes ON (S506). Alternatively, the access control section may notify the user that outputting of the list data is impossible and finish the process without waiting.

Step S507: The access control section of the CPU 137 reads out the latest updated date D1 of the list data stored in the storage server 11 from the storage server 11.

Step S508: The access control section of the CPU 137 compares the latest update date D1 with the latest update data D2 of the list data of the memory card 13 which is stored in the RAM 135 to determine which of the list data is newer.

Step S509: When the list data of the storage server 11 is newer, the access control section of the CPU 137 reads out the list data from the storage server 11. This can be performed by using, for example, the URL of the storage server 11, GET command of HTTP and RANGE specifier. The address specified by the RANGE specifier is obtained with reference to the FAT 139a before reading.

The access control section further merges the list data obtained from the storage server 11 and the list data in the memory card 13 which is stored in the RAM 135 to produce the latest list data. The generated list data is overwritten in the RAM 135.

Step S510: The access control section of the CPU 137 sends the list data in the RAM 135 to the terminal 14. Further, the access control section overwrites the list data of the non-authentication area 139c with the list data in the RAM 135 to update the list data of the memory card 13 to the latest state.

With the above-described process, the list outputting based on the latest list data is performed at the terminal 14. The list data respectively stored in the memory card 13 and the storage server 11 are updated to the latest state and stored in the memory card 13.

(4) Reading Process

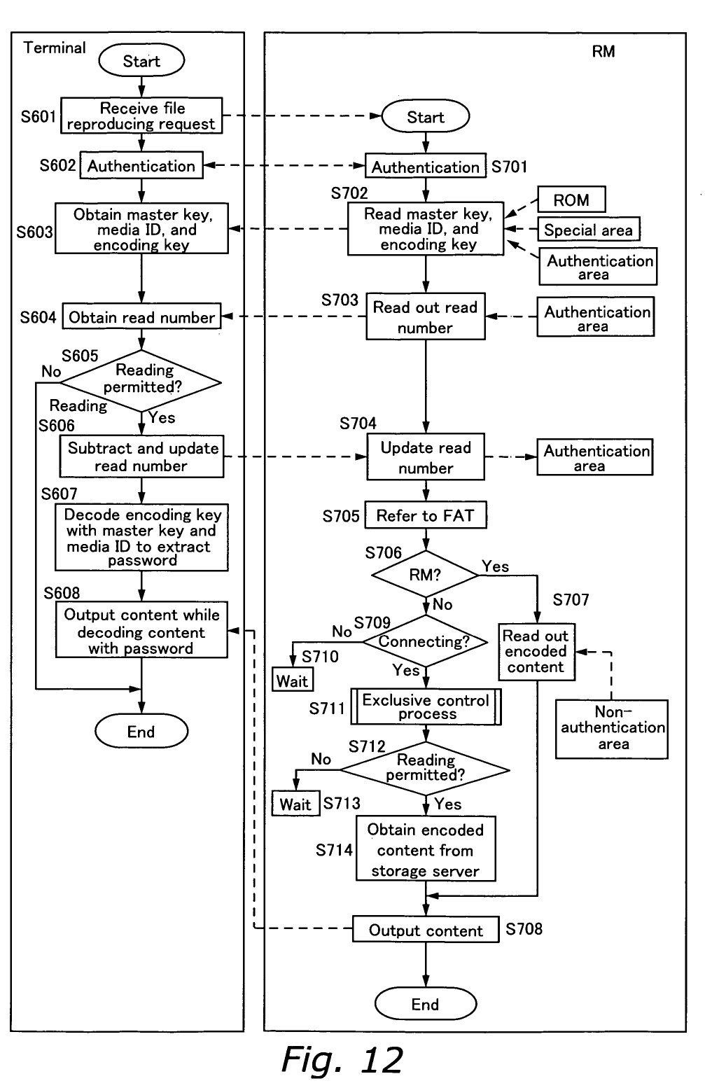

FIG. 12 is a flow diagram showing an exemplary flow of processes performed by the terminal 14 and the memory card 13 in the reading process. In these processes, content designated to be read out at the list output screen is read out from the memory card 13 or the storage server 11.

(4-1) Terminal

The terminal 14 performs a process of receiving designation of content from a user and obtaining the designated contents from the memory card 13 for outputting. When content is designated on the list output screen outputted by the above-described list outputting process, the following process is started.

Step S601: The microprocessor 142 of the terminal 14 passes data ID of the designated content to the memory card 13 and requests the memory card 13 to read out the content.

Steps S602 through S604: The processor of the terminal 14 performs authentication of the challenge and response type with the authentication section of the memory card 13 (S602). When authentication succeeds, the processor requests the memory card 13 to read out the master key, the media ID, the encoding key and the readout number, and obtains them (S603 and S604).

Step S605: The microprocessor 142 of the terminal 14 determines whether reading is permitted or not based on the readout number. If the readout number is “0”, reading is not permitted. If the number is 1 or more, it is determined that reading is permitted.

Step S606: If reading is permitted, the microprocessor 142 of the terminal 14 alters the number of times of reading and requests the memory card 13 to write new readout number. The remaining number of times the data to be read has to be decreased by one when the following process is performed.

Step S607: The microprocessor 142 of the terminal 14 decodes the encoding key obtained from the memory card 13 with the master key and the media ID and extracts password.

Step S608: The microprocessor 142 of the terminal 14 outputs the content received from the memory card 13 to the output device or a recording medium while it decodes it using the password.

(4-2) Memory Card

The memory card 13 reads out the content designated by the terminal 14 from the non-authentication area 139c in the flash memory 139 or the non-authentication area 111 of the storage server 11, and passes it to the terminal 14. When the memory card 13 receives reading out request from the terminal 14 with the data ID of the content, the following process is started. The following process can be broadly divided into preprocessing, reading out from the memory card, and reading out from the storage server.

(4-2-1) Preprocessing

Step S701: The authentication section of the CPU 137 performs authentication of the challenge-response type with the terminal 14.

Steps S702 and S703: If the authentication with the terminal 14 has been succeeded, the access control section of the CPU 137 reads out the master key, the media ID, and the encoding key respectively from the ROM 134, the special area 138, and the authentication area 139b in response to the reading out request from the terminal 14, and passes them to the terminal 14 (S702). Further, the access control section reads out the readout number from the authentication area 139b and passes it to the terminal 14 (S703).

Step S704: The access control section of the CPU 137 updates the readout number stored in the authentication area 139b in response to the request from the terminal 14.

Step S705: The access control section of the CPU 137 searches the FAT using the data ID of the content as a key and obtains the address at which the content is stored.

(4-2-2) Reading Out from Memory Card

Step S706: The space unification section of the CPU 137 determines whether the address of the destination for access obtained by the access control section is that of the memory card 13 or the storage server 11. If the access destination is the storage server 11, the space unification section reads out the URL of the storage server 11 from the NV-RAM 136 and passes it to the access control section.

Steps S707 and S708: When the address of the access destination is that of memory card 13, the access control section accesses the non-authentication area 139c in accordance with the address and reads out the encoded content (S707). The encoded content which is read out is decoded with the encoding/decoding circuit 1310 and sent to the terminal 14 (S708).

(4-2-3) Reading Out from Storage Server

Steps S709 and S710: When the address of the access destination is that of the storage server 11, the access control section determines whether there is a connection to the storage server 11 (S709). If there is a connection, the process moves to step S711 which will be described below. When there is no connection, the access control section enters a network connection waiting mode (S710). If a connection between the memory card 13 and the storage server 11 is established during the network connection waiting mode, the process moves to step S711.

Steps S711 through S713: When the address of the access destination is that of the storage server 11, the access control section of the CPU 137 performs the exclusive control process which will be described below (S711). The access control section determines whether reading out from the storage server 11 is permitted or not based on the result (S712). The determination is made based on whether the reproducing process permission flag or the time-shift reproducing process permission flag is switched ON. If both of the permission flags are OFF, the access control section waits until either one is switched ON (S713). Alternatively, the access control section may notify the user that the reading out process for the designated content is impossible and finish the process without waiting.

Step S714: When one of the permission flag is ON, the access control section obtains the encoded content from the storage server 11 in response to the permission flag which is ON. Specifically, the access control section accesses the address obtained at step S705, and obtains the encoded content from the storage server 11 via the encoding/decoding circuit 1310 and the wireless communication section 133. The obtained encoded content is temporarily stored in the RAM 135 and output to the terminal 14 (S708).

When the reproducing process permission flag is ON, the access control section can read out the designated content sequentially from the header address. However, when only the time-shift reproducing process permission flag is ON, the access control section reads out the designated content such that the address for writing of the content does not exceed the address for reading. As will be described below, the content is being recorded by another memory card 13 in such situation.

In the above-described processes, when the CPU 137 of the memory card 13 receives the reading out request from the terminal 14, it refers to the FAT to determine in which of the memory card 13 and the storage server 11 the data is stored. If the data is stored in the storage server 11, the CPU 137 reads out the data from the storage server 11. Therefore, when a user has a memory card 13, contents can be read out not only from the memory card 13 but also from the storage server 11. Thus, it seems that an apparent storage capacity of the memory card 13 increases.

Furthermore, since the passwords for encoding contents protected with copyrights and the encoded contents are stored separately, the security of the contents is guaranteed because even when the encoded content is obtained by an unauthorized party, the encoding key is not obtained by the unauthorized party at the same time.

(5) Exclusive Control Process

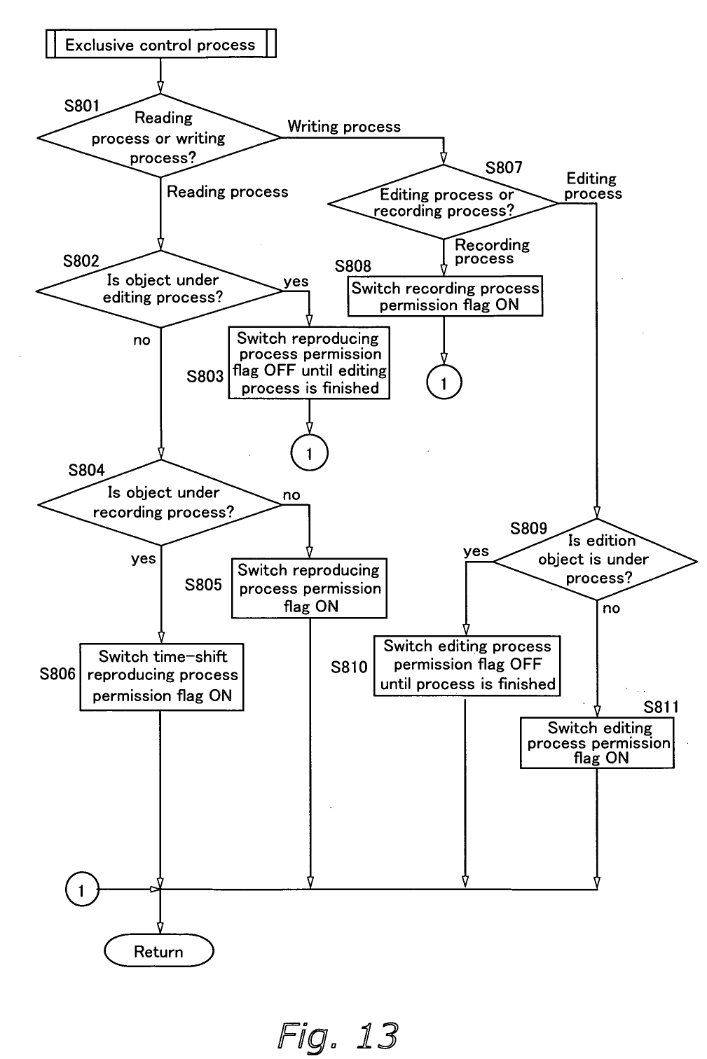

FIG. 13 is a flow diagram showing an exemplary flow of an exclusive control process performed by the memory card 13. In this process, a certain restriction is imposed on writing to or reading from an object for access on the storage server 11 when another memory card 13 is trying to access the same access object. More specifically, in this process, every time there is an access to the storage server 11, the following process is started.

Step S801: The contention determination section determines whether the generated access is intended for a reading process or a writing access. Herein, a reproducing process is taken as an example of the reading process and a recording process or an editing process is taken as an example of the writing process.

Step S802: When a reading process is generated, the contention determination section determines whether an object for reading is subjected to an editing process by another memory card 13 or not. The determination may be made based on a response to an inquiry to the storage server 11 asking the number of connections at the same time.

Step S803: If the object for reading is being edited by another memory card 13, the contention determination section switched OFF both the reproducing process permission flag and the time-shift reproducing process permission flag. In such a case, message such as “The data is being edited and cannot be reproduced” is output to the terminal 14. This prevents the object data to be reproduced from being rewritten by access from other semiconductor memory cards 13 while it is being reproduced.

Step S804: If the object for reading is not being edited by other memory cards 13, the contention determination section further determines whether the object for reading is under a recording process by another memory card 13 or not.

Step S805: If the object for reading is not under a recording process by other memory cards 13, the contention determination section sets the reproducing process permission flag to ON.

Step S806: If the object for reading is under a recording process by another memory card 13, the contention determination section sets the time-shift reproducing process permission flag to ON. This is for permitting reproduction within the range that the address for reading does not exceed the address for writing. During time-shift reproducing based on the time-shift reproducing process permission flag, when the reading address approaches the writing address due to fast-forward reproduction, the access control section can terminate fast-forward reproduction and changes to uniform speed reproduction.

Step S807: If it is determined that the access generated in step S801 is a writing process, the contention determination section further determines whether the writing process is an editing process or a recording process.

Step S808: If an access for a recording process is generated, the contention determination section sets the recording process permission flag to ON. This is because there is no contention with other memory cards 13 when new data is written.

Step S809: If an access for an editing process is generated, the contention determination section determines whether the object for editing is under any of the processes of recording, editing, and reproducing by access from other memory cards 13.

Step S810: While the object for editing is subjected to any kind of process, the contention determination section sets the editing process permission flag to OFF until the process is finished. When the process is finished, the editing process permission flag is switched to ON.

Step S811: The contention determination section sets the editing process permission flag to ON if there is no access from other memory cards 13 to the editing object. This can prevent the object data to be edited from being rewritten by an access from other memory cards 13.

With the above-described processes, it becomes possible to avoid the contention which may occur when a plurality of memory cards 13 access to one data on the storage server 11.

[Effects]

As described above, since the memory card 13 of the present invention includes the wireless communication section 133 and the connection section, it can access to the storage server 11 on a network. A non-authentication area and/or authentication area is provided on the storage server 11 and is managed in the memory card 13 as a memory space unified with the flash memory 139 in the memory card 13. In this way, memory space of the memory card 13 can be increased apparently. The memory spaces increased in this way can be accessed from any terminal 14 as long as the memory card 13 is used. This enhances convenience and flexibility for a user who wishes to store a large amount of data.

Further, by storing the encoded content protected with copyright in the storage server 11 and the encoding key required for decoding the content in the memory card 13, the security of the content can be guaranteed even when the encoded content is obtained by an unauthorized third party.

### Other Embodiments

(A) The system of Embodiment 1 includes only one storage server 11. However, the system may include a plurality of storage servers 11a, 11b, and so on. In such a case, the FAT of the memory card 13 manages addresses of storage areas of the storage servers 11a, 11b . . . in addition to the memory space in the memory card 13. The FAT further manages which of the address spaces are allocated to which of the storage servers 11. The NV-RAM 136 stores network address of the storage server 11.

(B) In Embodiment 1, an authentication area is provided only on the memory card 13. However, an authentication area (corresponding to a second authentication area) may be provided on the storage server 11. Providing an authentication area on the storage server 11 can apparently increase the authentication area on the memory card 13 as well. Therefore, even when data such as content is stored in the authentication area on the memory card 13 or the authentication area on the storage server 11 without encoding, a sufficient storage area can be prepared and the security of the content is guaranteed at the same time.

(C) In Embodiment 1, connection between the storage server 11 and the memory card 13 is established using the wireless communication section 133 and the connection section of the memory card 13. However, in the case where the terminal 14 has a communication function, the communication between the storage server 11 and the memory card 13 may be established using the communication function of the terminal 14. To use which of the communication functions can be determined automatically in view of the cost for communication and/or communication speed.

(D) Various user settings may be stored in the memory card 13 in order to use any terminal 14 with the settings. For example, user settings such as color setting for a user interface, a display of user name, a dominant hand may be stored into the memory card 13 to allow the user to use any terminal 14 other than user's own terminal 14 with the same settings as the own terminal 14.

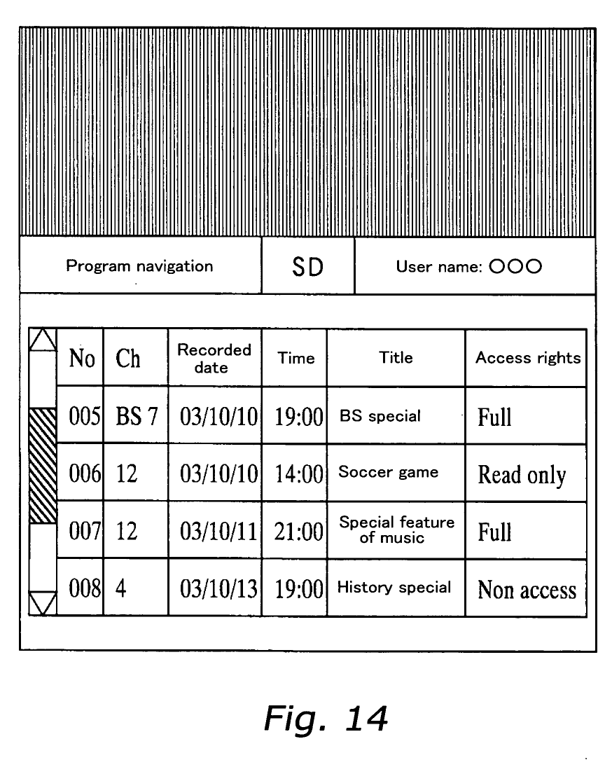

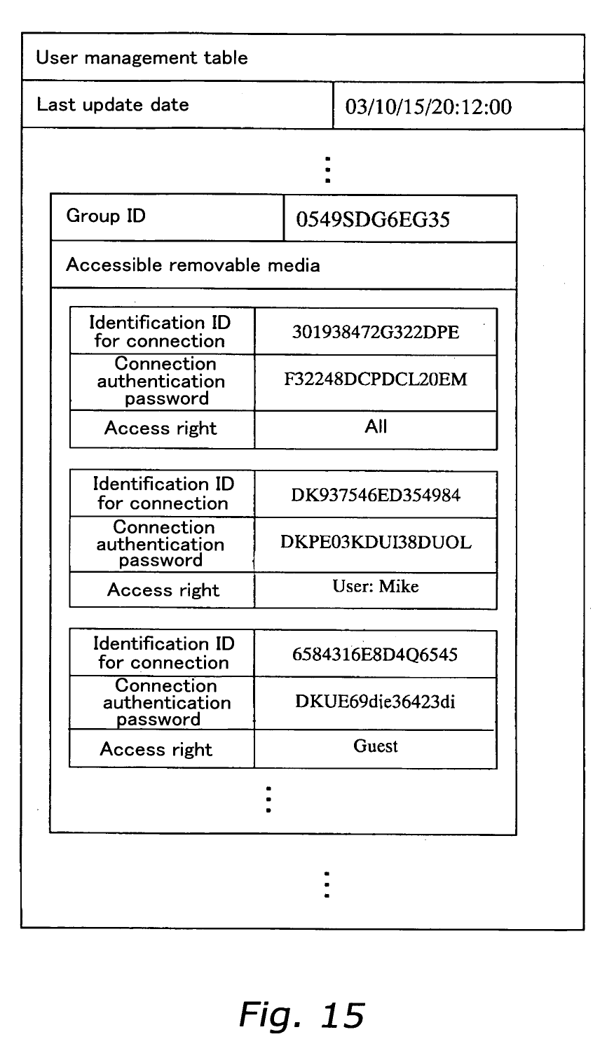

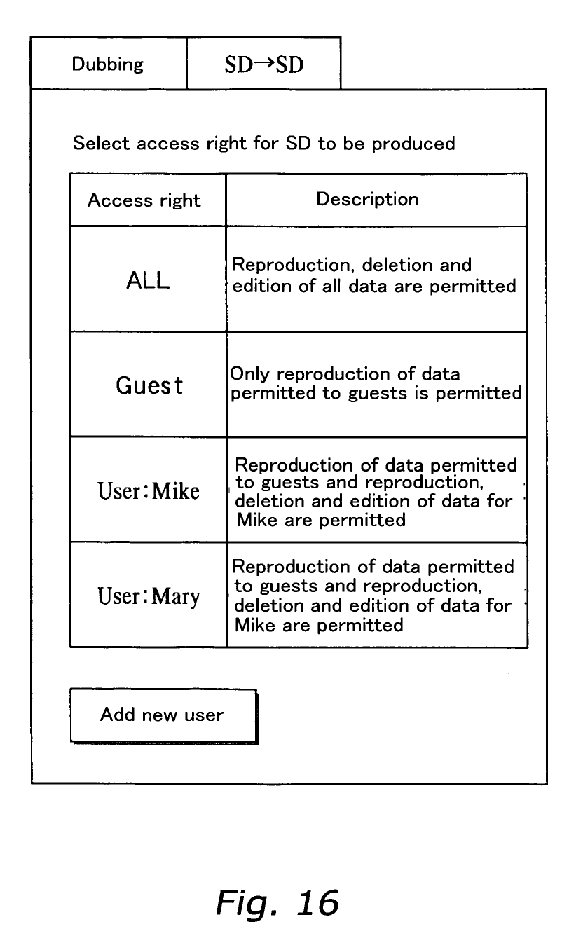

(E) Access rights may be managed by the storage server 11 when there is access to the storage server 11 having the identification IDs for connection as units. FIG. 14 shows an exemplary list displaying screen when there is an access right management. FIG. 15 shows exemplary data in the access right management table stored by the storage server 11. FIG. 16 shows an exemplary screen for producing the memory card 13 which can be accessed with different access rights to the storage server 11.

To the access right management for data files, techniques common in access right managements using file systems in computers can be applied.

(F) Attachable and removable semiconductor memory card is not limited to a memory card. Any type of portable recording media can be used as long as it can access a storage device on a network and has space unification unit which can unify a memory space of a recording medium and a memory space of the storage device. Other examples include a removable HDD unit, and an optical disc accommodated in a cartridge with a control mechanism according to the present invention.

(G) Basic concept of the present invention can be applied not only to recording media using semiconductor, but also to recording media utilizing optical method, magnetic method, or biotechnology.

(H) Programs for executing methods executed by the semiconductor memory card as described above are within the scope of the present invention. Further, computer readable recording media on which such a program is recorded is also within the scope of the present invention. The recording media may be a computer readable flexible disc, a hard disc, a semiconductor memory, a CD-ROM, a DVD, a magneto-optical disc (MO), or the like. The programs include programs stored in the recording media and programs which can be downloaded.

### INDUSTRIAL APPLICABILITY

The present invention is applicable to portable recording media which can be carried along and can be inserted into electronic equipment for writing or reading data.

1. A semiconductor memory card attachable and removable to and from electronic equipment, comprising:
a first rewritable nonvolatile memory;
first access control unit for controlling access by the electronic equipment to the first nonvolatile memory;
communication unit for controlling access by the electronic equipment to a storage device on a network which has a second rewritable nonvolatile memory;
second access control unit for controlling access by the electronic equipment to the second nonvolatile memory; and
space unification unit for forming a virtual unified memory space including the first nonvolatile memory and the second nonvolatile memory.

2. A semiconductor memory card according to claim 1, further comprising contention determination unit for determining whether data to be accessed by the second access control unit is being written or read by other semiconductor cards, and for starting, stopping, or delaying writing and/or reading by the second access control unit based on the determination result.

3. A semiconductor memory card according to claim 1, wherein the communication unit stores address of the storage device on the network.

4. A semiconductor memory card according to claim 3, wherein the communication unit accesses the storage device using identification information of the semiconductor memory card.

5. A semiconductor memory card according to claim 1, further comprising:
encoding unit for generating an encoding key for encoding the data and for encoding the data with the encoding key; and
authentication unit for verifying validity of the electronic equipment, wherein:
the first nonvolatile memory includes a first authentication area and a first non-authentication area which are predetermined storage areas;
the first access unit controls access by the electronic equipment to the first non-authentication area and permits the access by the electronic equipment to the first authentication area when the authentication unit authenticates the validity of the electronic equipment;
the second access unit controls access by the electronic equipment to second non-authentication area which is a predetermined storage area included in the second nonvolatile memory; and
the space unification unit allocates address of the second non-authentication area in the second nonvolatile memory to the data encoded with the encoding key, and allocates the address of the first authentication area in the first nonvolatile memory to the encoding key.

6. A semiconductor memory card according to claim 5, wherein the space unification unit determines which of the addresses of the first non-authentication area in the first nonvolatile memory and the second non-authentication area in the second nonvolatile memory is allocated to the data encoded with the encoding key, and allocates the address to the data in accordance with the determination.

7. A semiconductor memory card according to claim 5, wherein the second access unit permits access by the electronic equipment to the second authentication area which is a predetermined storage area in the second nonvolatile memory when the authentication unit authenticates validity of the electronic equipment.

8. A semiconductor memory card according to claim 1, wherein:
the first nonvolatile memory includes a management area;
the space unification unit allocates address in the first nonvolatile memory or the second nonvolatile memory to data, and writes data identifier for identifying the data into the management area with being associated with the allocated address;
the first access unit and the second access unit receives a request for writing the data to the first nonvolatile memory or the second nonvolatile memory, and write the data to a storage area corresponding to the address allocated to the data.

9. A semiconductor memory card according to claim 8, wherein the second access unit receives a request for reading data, reads address of the second nonvolatile memory on which the data is written from the management area, and accesses the read out address via the communication unit to read out the data.

10. A semiconductor memory card according to claim 8, further comprising encoding unit for generating an encoding key for encoding or decoding the data, and for encoding the data with the encoding key, wherein:
the second access unit reads out address of the second non-authentication area on which the data encoded with the encoding key is written from the management area, and accesses the address of the second non-authentication area to read out the encoded data via the communication unit; and
the first access unit reads out address of the first non-authentication area on which the encoding key is written from the management area, and accesses the address of the first non-authentication area to read out the encoding key.

11. A memory space management method, comprising:
a first access control step for controlling access by electronic equipment to a first rewritable nonvolatile memory;
a communication step for controlling access by the electronic equipment to a storage device on a network which has a second rewritable nonvolatile memory;
a second access control step for controlling access by electronic equipment to the second nonvolatile memory; and
a space unification step for forming a virtual unified memory space including the first nonvolatile memory and the second nonvolatile memory.

12. A memory space management program which is recorded on a semiconductor memory card which is attachable and removable to and from electronic equipment and includes a computer, causing the computer to function as:
first access control unit for controlling access by electronic equipment to a first rewritable nonvolatile memory;
communication unit for controlling access by the electronic equipment to a storage device on a network which has a second rewritable nonvolatile memory;
second access control unit for controlling access by electronic equipment to the second nonvolatile memory; and
space unification unit for forming a virtual unified memory space including the first nonvolatile memory and the second nonvolatile memory.
